(19) United States
(12) Patent Application Publication
(10) Pub. No.: US 2026/0208797 A1
(43) Pub. Date: Jul. 23, 2026

(54) MOUNTING STRUCTURE OF A TAILGATE

(71) Applicant: TOYOTA JIDOSHA KABUSHIKI KAISHA, Aichi-ken (JP)

(72) Inventor: Shoichiro KAWAJI, Toyota-shi (JP)

(21) Appl. No.: 19/414,270

(22) Filed: Dec. 10, 2025

(30) Foreign Application Priority Data
Jan. 21, 2025 (JP) 2025-008683

(51) Int. Cl. B62D 33/027

(52) U.S. Cl. CPC B62D 33/0273

(57) ABSTRACT

A mounting structure of a tailgate, the mounting structure comprises the tailgate disposed at a rear end of a loading platform of a vehicle; and a hinge swingably connecting the tailgate to a body of the vehicle, the hinge including a gate-side component fastened to the tailgate and a body-side component fastened to the body. The gate-side component has a fitting projection projecting toward the body-side component. The body-side component has a cylindrical portion that covers an entire circumference of the fitting projection. In the cylindrical portion, a fitting recess to be fitted with the fitting projection is formed.

### CROSS REFERENCE TO RELATED APPLICATION

This application claims priority to Japanese Patent Application No. 2025-008683 filed on Jan. 21, 2025, which is incorporated herein by reference in its entirety including the specification, claims, drawings, and abstract.

### TECHNICAL FIELD

This specification discloses a mounting structure for pivotally mounting a tailgate to a rear end of a loading platform of a vehicle.

### BACKGROUND

Conventionally, a vehicle having a loading platform, such as a pickup truck, has been widely known. For example, Patent Document 1 discloses a vehicle having a loading platform and a tailgate mounted to a rear end of the loading platform. The tailgate is swingable about an axis passing through the vicinity of the lower end of the tailgate. By swinging the tailgate, the rear end of the loading platform is opened and closed.

Typically, the tailgate is mounted to a body of the vehicle via a hinge member. The hinge member includes a gate-side component fastened to the tailgate and a body-side component fastened to the body of the vehicle.

When the tailgate is mounted to the vehicle body, the gate-side component is fastened to the tailgate and the body-side component is fastened to the body in advance. Thereafter, the gate-side component is assembled to the body-side component. In order to enable this assembly, conventionally, the body-side component is provided with a recess for receiving a part of the gate-side component and a notch for allowing the gate-side component to enter the recess.

In such a conventional structure, the tailgate can be easily assembled to the vehicle. On the other hand, in the case of the conventional structure, it is also possible to remove the tailgate from the vehicle after the vehicle is completed. As a result, the tailgate may be stolen.

Therefore, the present specification discloses a tailgate mounting structure capable of effectively preventing theft of the tailgate.

### CITATION LIST

PATENT LITERATURE 1: JP 2011-519766 A

### SUMMARY

A tailgate mounting structure disclosed in this specification, the mounting structure comprising: the tailgate disposed at a rear end of a loading platform of a vehicle; and a hinge swingably connecting the tailgate to a body of the vehicle, the hinge including a gate-side component fastened to the tailgate and a body-side component fastened to the body, wherein the gate-side component has a fitting projection projecting toward the body-side component, the body-side component has a cylindrical portion that covers an entire circumference of the fitting projection, and in the cylindrical portion, a fitting recess to be fitted with the fitting projection is formed.

In this case, the mounting structure may further comprise a bumper that covers a part of the body and conceals a fastening portion between the body-side component and the body.

An axial direction of the fitting projection, an axial direction of the fitting recess, and an assembling direction of the body-side component to the body may be substantially parallel to a width direction of the vehicle.

The mounting structure may further comprises a damper stay connected to the body-side component, wherein the tailgate may have a license mounting portion on which a license plate is to be mounted.

Another tailgate mounting structure disclosed in this specification, the mounting structure comprising: the tailgate disposed at a rear end of a loading platform of a vehicle; and a hinge swingably connecting the tailgate to a body, the hinge including a gate-side component fastened to the tailgate, a body-side component fastened to the body, and an auxiliary component, wherein the gate-side component has a fitting projection projecting toward the body-side component, the body-side component has a cylindrical portion, the cylindrical portion has a fitting recess to be fitted to the fitting projection and a peripheral surface on which a notch that allows the fitting projection to pass therethrough is formed, and the auxiliary component has a terminal portion bent from a side opposite from the notch so as to cover the cylindrical portion, and an arm portion fastened to the tailgate.

According to the first technology disclosed in this specification, the entire periphery of the fitting projection is covered with the cylindrical portion. Therefore, the tailgate cannot be removed from the vehicle only by pulling the tailgate in one direction. Further, according to the second technique, when the tailgate is pulled in the separating direction, the tailgate cannot be removed from the vehicle because the distal end portion of the auxiliary component interferes with the cylindrical portion. As a result, in both the first technique and the second technique, theft of the tailgate is effectively prevented.

### BRIEF DESCRIPTION OF DRAWINGS

Embodiments of the present disclosure will be described based on the following figures, wherein:

FIG. 1 is a perspective view of a vehicle having a tailgate;

FIG. 2 is a cross-sectional view of the periphery of a hinge;

FIG. 3 is an exploded perspective view of a hinge;

FIG. 4 is a cross-sectional view taken along line A-A in FIG. 2;

FIG. 5 is a schematic view illustrating another example of the mounting structure of the tailgate; and

FIG. 6 is a diagram illustrating a hinge of a comparative example.

### DESCRIPTION OF EMBODIMENTS

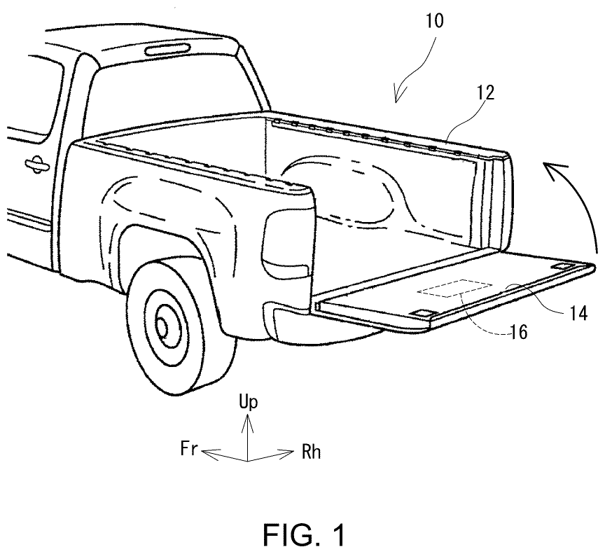

Hereinafter, a mounting structure of the tailgate 14 will be described with reference to the drawings. FIG. 1 is a perspective view of a vehicle 10 having a tailgate 14. In the drawings, Fr, Up, and Rh indicate the front, upper, and right sides of the vehicle 10.

As shown in FIG. 1, the vehicle 10 has a loading platform 12. An openable tailgate 14 is mounted to the rear end of the loading platform 12. The tailgate 14 is opened and closed by swinging around an axis set in the vicinity of the lower end of the tailgate 14. The tailgate 14 is swingably coupled to the body 18 via a hinge 30 described later. The hinge 30 is attached to both the left and right ends of the lower end of the tailgate 14.

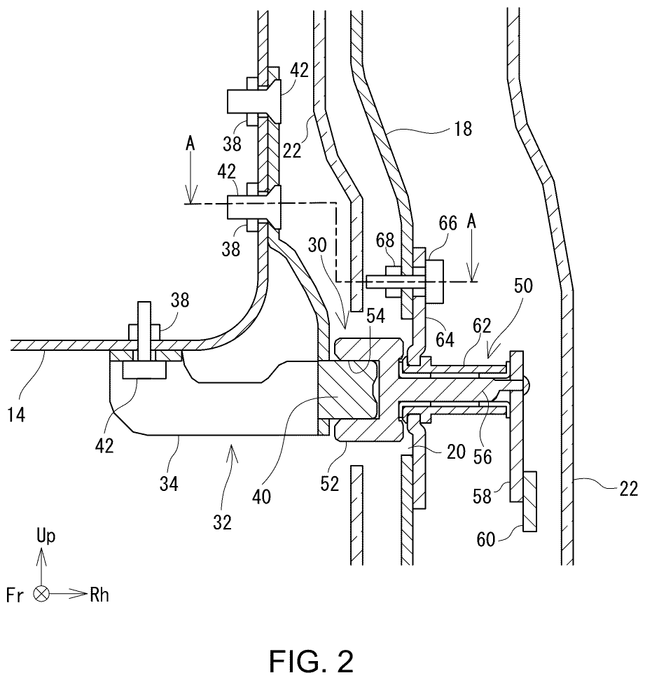

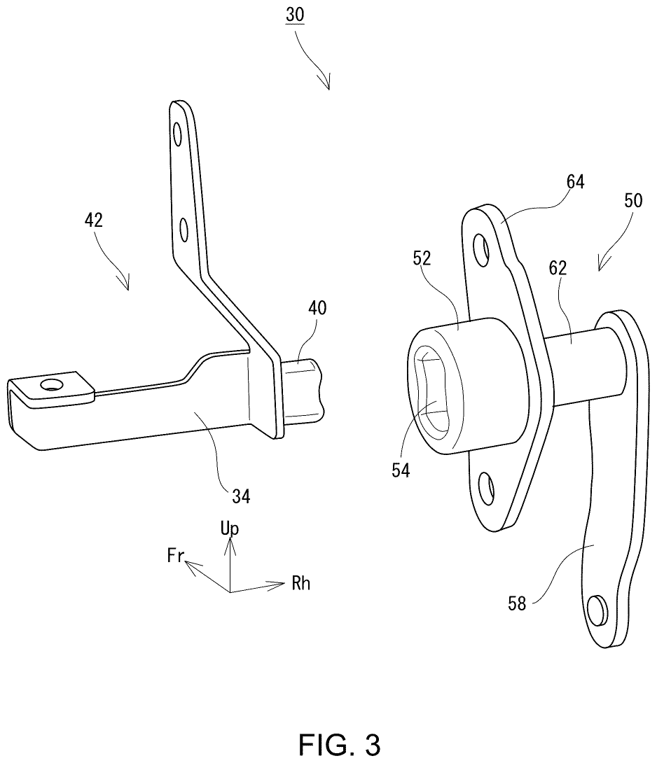

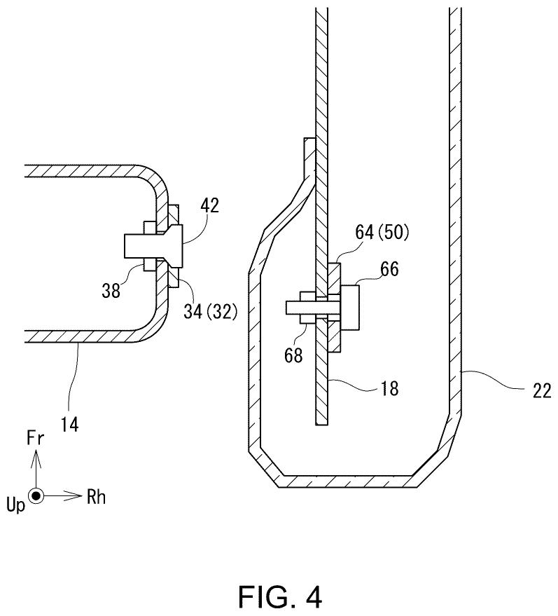

FIG. 2 is a cross-sectional view of the periphery of the hinge 30. FIG. 3 is an exploded perspective view of the hinge 30. FIG. 4 is a cross-sectional view taken along line A-A in FIG. 2. As shown in FIGS. 2 and 3, the hinge 30 is roughly divided into a gate-side component 32 and a body-side component 50. The gate-side component 32 is a component that is fastened to the tailgate 14. The gate-side component 32 includes a fastening bracket 34 fastened to the tailgate 14, and a fitting projection 40 fixed to the fastening bracket 34. The fastening bracket 34 is substantially L-shaped along the corner of the lower corner of the tailgate 14. The fastening bracket 34 is fastened to each of the left and right end surfaces of the tailgate 14 and the bottom surface of the tailgate 14. In order to enable this fastening, a weld nut 38 is fixed to each of the left and right end surfaces of the tailgate 14 and the bottom surface of the tailgate 14.

The fitting projection 40 protrudes outward in the vehicle width direction from the fastening bracket 34. The fitting projection 40 has a non-circular cross-section. In the example of FIG. 3, the fitting projection 40 has a substantially peanut-shaped cross section.

The body-side component 50 is a component that is fastened to the body 18 of the vehicle 10. The body-side component 50 includes a rotating shaft 56, a coupling bar 58, a bearing 62, and a fastening flange 64. The fastening flange 64 is fixed to the outer peripheral surface of the bearing 62. The fastening flange 64 is fastened to the body 18 from the outside in the vehicle width direction. In order to enable this fastening, a weld nut 68 is fixed to an inner end surface of the body 18 in the vehicle width direction. The bearing 62 is fixed to the body 18 by fastening the fastening flange 64 to the body 18.

The bearing 62 rotatably supports the rotating shaft 56. The bearing 62 and the rotating shaft 56 are disposed in a posture substantially parallel to the vehicle width direction. A cylindrical portion 52 is provided at one end of the rotating shaft 56. The body 18 is formed with an assembly hole 20 that allows the cylindrical portion 52 to pass therethrough.

A fitting recess 54 for receiving the fitting projection 40 is formed in the cylindrical portion 52. The fitting recess 54 has a cross-sectional shape that is substantially the same as the cross-sectional shape of the fitting projection 40. In other words, each of the fitting recess 54 and the fitting projection 40 has a non-circular cross-sectional shape. Therefore, when the fitting projection 40 is fitted into the fitting recess 54, the rotating shaft 56 and the fitting projection 40 integrally rotate about the rotating shaft 56. This allows the tailgate 14 to swing. Here, the fitting recess 54 covers the entire periphery of the fitting projection 40. Therefore, when the fitting projection 40 is fitted into the fitting recess 54, it is necessary to insert the fitting projection 40 into the fitting recess 54 in the axial direction (that is, the vehicle width direction).

A coupling bar 58 is fixed to the other end of the rotating shaft 56. The coupling bar 58 rotates together with the rotating shaft 56. A damper stay 60 is fastened to the lower end of the coupling bar 58. The damper stay 60 has a damper (not shown), and absorbs an impact generated when the tailgate 14 is opened and closed.

The periphery of the body 18 is covered with a bumper 22. The bumper 22 is a design panel provided on the outer surface of the vehicle 10. The bumper 22 is attached to the body 18 by a fastening member (e.g., a grommet or a screw). The bumper 22 is fastened to the body 18 after the assembly of the hinge 30 and the tailgate 14 is completed. As shown in FIG. 4, the bumper 22 completely covers the fastening bolt 66 of the body-side component 50. Therefore, in a state where the bumper 22 is fastened to the body 18, the fastening bolt 66 cannot be attached and detached.

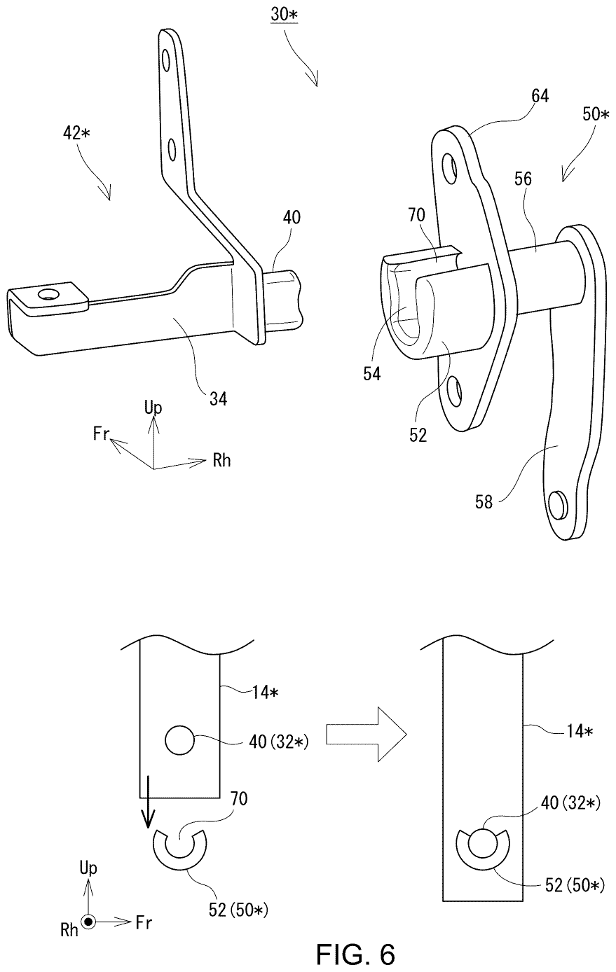

The reason why the above configuration is employed will be described in comparison with a comparative example. The upper part of FIG. 6 is an exploded perspective view of the hinge 30* of the comparative example. Further, the lower part of FIG. 6 is a schematic view showing the state of assembly of the tailgate 14* of the comparative example.

As shown in FIG. 6, in the hinge 30* of the comparative example, a notch 70 is formed in the cylindrical portion 52 of the body-side component 50*. The width of the notch 70 is slightly smaller than the width of the fitting projection 40 of the gate-side component 32*. When mounting the tailgate 14* to the vehicle 10, the operator press-fits the fitting projection 40 of the gate-side component 32* into the notch 70 of the body-side component 50*. That is, in the case of the comparative example, the operator fastens the gate-side component 32* to the tailgate 14* and fastens the body-side component 50* to the body 18 in advance. Thereafter, the tailgate 14* is disposed in an upright posture at the rear end of the loading platform 12, and the tailgate 14* is pushed downward from above so that the fitting projection 40 passes through the notch 70.

With such a configuration, the tailgate 14* can be attached to the vehicle 10 by a simple operation. However, in the case of the comparative example, a notch 70 through which the fitting projection 40 can pass is formed in the cylindrical portion 52. Therefore, after the tailgate 14* is mounted to the vehicle, the gate-side component 32* can be easily detached from the body-side component 50* by strongly pulling the tailgate 14* upward. Then, the tailgate 14* is separated from the vehicle 10 by disassembling the hinge 30*. As a result, in the case of the structure of the comparative example, the tailgate 14* may be stolen.

On the other hand, in the case of the configuration of the present example, as described above, the cylindrical portion 52 does not have the notch 70, and covers the entire periphery of the fitting projection 40. Therefore, in order to separate the gate-side component 32 and the body-side component 50 fitted to each other, it is necessary to move the body-side component 50 outward in the vehicle width direction (i.e., to the rotation axis 56). In order to move the body-side component 50 outward in the vehicle width direction, it is necessary to remove the fastening bolt 66. However, in this example, the periphery of the fastening bolt 66 is covered with the bumper 22. Therefore, in the case of the present example, since the fastening bolt 66 cannot be easily removed after the vehicle 10 is completed, the hinge 30 cannot be easily disassembled. As a result, theft of the tailgate 14 is effectively prevented.

Here, in the case of the present example, the tailgate 14 is mounted in the following procedure. The operator first fastens the gate-side component 32 to the tailgate 14. Subsequently, the operator disposes the tailgate 14 at the rear end of the loading platform 12. In this state, the operator passes the cylindrical portion 52 of the body-side component 50 through the assembly hole 20 from the outside in the vehicle width direction, and fits the fitting projection 40 into the fitting recess 54. At this time, the tailgate 14 and the body-side component 50 are positioned so that the fitting recess 54 of the body-side component 50 is fitted to the fitting projection 40 of the gate-side component 32. When the fitting projection 40 is fitted into the fitting recess 54, the operator fastens the fastening flange 64 to the body 18. At this time, the bumper 22 is not attached to the body 18 of the vehicle 10. Therefore, the operator can easily perform the fitting operation of the fitting projection 40 and the fastening operation of the fastening flange 64.

When the body-side component 50 can be fastened to the body 18, the operator then couples the damper stay 60 to the coupling bar 58. Thereafter, the operator fastens the bumper 22 to the body 18. As a result, since the fastening bolts 66 of the body-side component 50 are hidden, disassembly of the hinge 30 and theft of the tailgate 14 are effectively prevented.

Here, since the tailgate 14 is prevented from being stolen, important parts can be mounted on the tailgate 14. For example, a license mounting portion 16 (see FIG. 1) may be provided on the rear end surface of the tailgate 14. By providing the tailgate 14 with the license mounting portion 16, the degree of freedom of design around the loading platform 12 is improved.

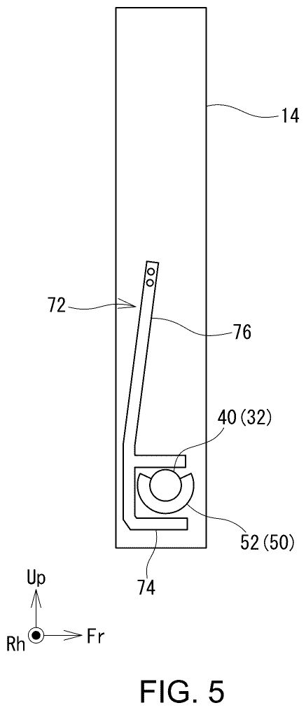

Next, another embodiment will be described with reference to FIG. 5. FIG. 5 is a schematic view illustrating another example of the mounting structure of the tailgate 14. The mounting structure of this example has the same hinge 30* as the hinge 30* of the comparative example shown in FIG. 6. That is, the body-side component 50* of the hinge 30* has a notch 70 that allows the fitting projection 40 to pass therethrough. The mounting structure of the example of FIG. 5 further includes an auxiliary component 72. The auxiliary component 72 is a sheet metal member fastened to the side surface of the tailgate 14. The auxiliary component 72 has a terminal portion 74 and an arm portion 76.

The terminal portion 74 is a substantially U-shaped portion surrounding the circumference of the cylindrical portion 52. In other words, the distal end of the terminal portion 74 is bent so as to cover the cylindrical portion 52 from the opposite side of the notch 70 (i.e., the lower side in FIG. 5). The arm portion 76 is a portion extending upward from the terminal portion 74. The upper end of the arm portion 76 is fastened to the side surface of the tailgate 14. Such auxiliary component 72 is fastened to tailgate 14 in an orientation such that terminal portion 74 surrounds the perimeter of hinge 30*.

The auxiliary component 72 is fastened to the tailgate 14 after the gate-side component 32 is fitted to the body-side component 50. That is, in this case, the operator first fastens the gate-side component 32 to the tailgate 14, and fastens the body-side component 50 to the body 18. Subsequently, the operator places the tailgate 14 in an upright posture at the rear end of the loading platform 12, and inserts the fitting projection 40 of the gate-side component 32 into the notch 70 of the body-side component 50. As a result, the tailgate 14 is mounted to the vehicle. Thereafter, the operator opens the tailgate 14, that is, the tailgate 14 protrudes rearward from the rear end of the loading platform 12. Then, the operator positions the auxiliary component 72 so that the terminal portion 74 surrounds the circumference of the cylindrical portion 52, and then fastens the auxiliary component 72 to the side surface of the tailgate 14. As a result, the periphery of the cylindrical portion 52 is surrounded by the terminal portion 74 of the auxiliary component 72. As a result, even if the tailgate 14 is lifted upward, the terminal portion 74 interferes with the cylindrical portion 52. This prevents the tailgate 14 from being detached from the vehicle 10.

As is clear from the above description, even when the body-side component 50 has the notch 70, theft of the tailgate 14 can be effectively prevented by using the auxiliary component 72. In the above description, the auxiliary component 72 is attached in the manufacturing process of the vehicle 10. However, the auxiliary component 72 may be applied to an existing vehicle 10 delivered to an individual user. By applying the auxiliary component 72, it is possible to effectively prevent theft of the tailgate 14 without performing a large-scale operation (for example, an operation of replacing the hinge 30) on the existing vehicle 10.

Note that all of the configurations described above are examples, and other configurations may be appropriately changed as long as the configurations described in the independent claims are included. For example, in the above description, the pickup track is described as an example. However, the technology disclosed herein may be applied to other forms of vehicle 10 as long as it has tailgate 14 and loading platform 12. In the above description, the fastening portion of the body-side component 50 is covered with the bumper 22. However, the fastening portion of the body-side component 50 may not be covered with the bumper 22 as long as the design can be ensured. A certain amount of time is required to release the fastening of the body-side component 50. Therefore, even if the fastening portion of the body-side component 50 is exposed to the outside, it takes a certain amount of time to remove the tailgate 14, so that theft of the tailgate 14 is effectively prevented.

### REFERENCE SIGNS LIST

10 vehicle, 12 loading platform, 14 tailgate, 16 license mounting portion, 18 body, 20 assembly hole, 22 bumper, 30 hinge, 32 gate-side component, 34 fastening bracket, 38 weld nut, 40 fitting projection, 50 body-side component, 52 cylindrical portion, 54 fitting recess, 56 rotating shaft, 58 coupling bar, 60 damper stay, 62 bearing, 64 fastening flange, 66 fastening bolt, 68 weld nut, 70 notch, 72 auxiliary component, 74 terminal portion, 76 arm portion.

1. A mounting structure of a tailgate, the mounting structure comprising:
the tailgate disposed at a rear end of a loading platform of a vehicle; and
a hinge swingably connecting the tailgate to a body of the vehicle, the hinge including a gate-side component fastened to the tailgate and a body-side component fastened to the body, wherein
the gate-side component has a fitting projection projecting toward the body-side component,
the body-side component has a cylindrical portion that covers an entire circumference of the fitting projection, and
in the cylindrical portion, a fitting recess to be fitted with the fitting projection is formed.

2. The mounting structure for the tailgate according to claim 1, further comprising:
a bumper that covers a part of the body and conceals a fastening portion between the body-side component and the body.

3. The mounting structure for the tailgate according to claim 1,
an axial direction of the fitting projection, an axial direction of the fitting recess, and an assembling direction of the body-side component to the body are substantially parallel to a width direction of the vehicle.

4. The mounting structure of the tailgate according to claim 1, further comprising:
a damper stay connected to the body-side component, wherein the tailgate has a license mounting portion on which a license plate is to be mounted.

5. A mounting structure of a tailgate, the mounting structure comprising:
the tailgate disposed at a rear end of a loading platform of a vehicle; and
a hinge swingably connecting the tailgate to a body, the hinge including a gate-side component fastened to the tailgate, a body-side component fastened to the body, and an auxiliary component, wherein
the gate-side component has a fitting projection projecting toward the body-side component,
the body-side component has a cylindrical portion,
the cylindrical portion has a fitting recess to be fitted to the fitting projection and a peripheral surface on which a notch that allows the fitting projection to pass therethrough is formed, and
the auxiliary component has a terminal portion bent from a side opposite from the notch so as to cover the cylindrical portion, and an arm portion fastened to the tailgate.
